(19) United States
(12) Patent Application Publication
(10) Pub. No.: US 2025/0208368 A1
(43) Pub. Date: Jun. 26, 2025

(54) LENS ADAPTER BRACKET

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 18/987,329

(22) Filed: Dec. 19, 2024

(30) Foreign Application Priority Data
Dec. 20, 2023 (CN) 2023234880396

(51) Int. Cl. G02B 7/02

(52) U.S. Cl. CPC G02B 7/02

(57) ABSTRACT

A lens adapter bracket, which includes a mounting bracket and a lens bracket, is disclosed. The mounting bracket is detachably mounted on a electronic device and is designed to be positioned at the lens location of the electronic device. Openings are provided on the mounting bracket to expose the camera lens, flashlight, and recording hole. The lens bracket is utilized to mount an optical element and is detachably connected to the mounting bracket. The optical element, mounted on the lens bracket, is fixed onto the mounting bracket along with the lens bracket, thereby covering the electronic device's camera lens for shooting. Users can conveniently hold the electronic device to shoot using various attached optical elements (e.g., lens and filters). The detachable connection for removing the optical element simplifies the its replacement process and significantly reduces the steps involved in lens or filter change and disassembly.

### CROSS-REFERENCE TO RELATED APPLICATIONS

The present application for patent claims priority to and the benefit of pending Chinese Application No. 2023234880396, filed Dec. 20, 2023, and hereby expressly incorporated by reference herein as if fully set forth below in its entirety and for all applicable purposes.

### TECHNICAL FIELD

The present invention pertains to the technical field of photographic tools, specifically to a lens adapter bracket.

### INTRODUCTION

With the widespread adoption of photography and videography in everyday life, an increasing number of individuals engage in shooting activities. Consequently, there has been a corresponding rise in demand for enhanced photographic and videographic capabilities in electronic devices. In recent years, advancements in mobile phone cameras have encouraged more photographers to utilize mobile phones for shooting, making mobile phone photography an integral aspect of emerging photographic trends.

However, practical shooting scenarios are often complex. To achieve desired photographic effects, photographers require various compositions, such as applying different optical elements (e.g., filters or lenses) to different scenes during shooting. The challenge arises in facilitating the use of filters with mobile phones.

In existing technologies, to achieve the desired shooting effects with mobile phone cameras, users either hold external lenses or filters directly with their hands for adjustment, leading to poor shooting results due to hand movements, or they use installation structures to mount external filters on mobile phones. In such cases, when users need to use the phone's original camera or change filters, they have to remove and replace the entire filter assembly, which is cumbersome and costly.

### BRIEF SUMMARY

The present invention provides a lens adapter bracket that allows for rapid exchange of lenses with various effects, thereby facilitating the use of lenses with electronic devices for shooting.

One aspect of the present invention provides a lens adapter bracket, which includes a mounting bracket and a lens bracket.

The mounting bracket is detachably mounted on an electronic device kit and is designed to be positioned at the lens location of the electronic device. Openings are provided on the mounting bracket to expose the camera lens, flashlight, and recording hole. The lens bracket is utilized to mount a lens and is detachably connected to the mounting bracket.

The lens adapter bracket, according to the aforementioned embodiment, includes a mounting bracket and a lens bracket that are independently configured and detachably connected. The mounting bracket can be detachably mounted on electronic devices, such as mobile phones. The lens bracket is capable of holding lenses with various effects. Therefore, after installing the mounting bracket on an electronic device, the lens bracket can be easily detached without the need to dismantle the entire mounting bracket, simplifying the detachment process. Furthermore, lenses can be freely replaced by swapping the lens bracket, thereby facilitating lens changes while ensuring stable shooting and photographic quality.

### BRIEF DESCRIPTION OF THE DRAWINGS

FIG. 1 is a schematic illustrating an overall assembly of a lens adapter bracket for a mobile phone according to some aspects of the disclosure;

FIG. 2 is a schematic illustrating an overall structure of the lens adapter bracket according to some aspects of the disclosure;

FIG. 3 is a schematic illustrating a side view of the lens adapter bracket according to some aspects of the disclosure;

FIG. 4 is a cross-sectional diagram of the lens adapter bracket of FIG. 3;

FIG. 5 is a schematic illustrating an exploded view of the lens adapter bracket according to some aspects of the disclosure;

FIG. 6 is a schematic illustrating an exploded view of the lens adapter bracket according to some aspects of the disclosure;

FIG. 7 is a schematic illustrating an enlarged view of part A in FIG. 4.

Reference numerals of elements in the drawings: 1, mounting bracket; 11, quick-release part; 12, rotating part; 121, mounting part; 122, positioning part; 123, opening; 124, limiting slot; 125, limiting part; 126, step surface; 127, unloading slot; 128, clamping slot; 129, positioning block; 2, lens bracket; 21, connecting part; 22, lens part; 23, fixture block; 24, positioning notch; 25, catch groove; 3, magnet; 4, lens.

### DETAILED DESCRIPTION

Further detailed descriptions of the present disclosure are provided below through specific embodiments in conjunction with the drawings. Similar components in different embodiments adopt associated and similar component labels. In the following embodiments, numerous detailed descriptions are provided to better understand the present disclosure. However, those skilled in the art can readily recognize that some features can be omitted in different scenarios or replaced by other components, materials, or methods. In some cases, some operations related to the present disclosure are not shown or described in the specification to avoid overwhelming the core part of the present disclosure with excessive descriptions. For those skilled in the art, detailed descriptions of these related operations are not necessary, as they can fully understand the relevant operations based on the descriptions in the specification and general technical knowledge in the field.

Additionally, the characteristics, operations, or features described in the specification can be combined in any suitable manner to form various embodiments, and the operational steps involved in each embodiment can be swapped or adjusted in an obvious manner to those skilled in the art. Therefore, the specification and drawings are intended only to clearly describe a particular embodiment and do not imply a necessary composition and/or sequence.

The serial numbers assigned to components in this document, such as “first” and “second”, are solely used to distinguish the described objects and do not carry any sequential or technical meaning. The terms “connect” and “link” in this disclosure, unless otherwise specified, encompass both direct and indirect connections (linkages).

With the widespread adoption of photography and videography in everyday life, an increasing number of individuals engage in shooting activities. Consequently, there has been a corresponding rise in demand for enhanced photographic and videographic capabilities in electronic devices. In recent years, advancements in mobile phone cameras have encouraged more photographers to utilize mobile phones for shooting, making mobile phone photography an integral aspect of emerging photographic trends. However, practical shooting scenarios are often complex. To achieve desired photographic effects, photographers require various compositions, such as applying different optical elements (e.g., filters and lenses) to different scenes during shooting. The challenge arises in facilitating the use of filters with mobile phones.

Currently, to achieve the desired shooting effects with mobile phone cameras, users either hold external lenses or filters directly with their hands for adjustment, leading to poor shooting results due to hand movements, or they use installation structures to mount external lenses or filters on mobile phones. In such cases, when users need to use the phone's original camera or change filters/lenses, they have to remove and replace the entire filter or lens assembly, which is cumbersome and costly.

The present disclosure provides a lens adapter bracket that enables the rapid replacement of various optical elements (e.g., lenses and filters) with different effects through the independent and quickly detachable mounting bracket and lens bracket. This is facilitated by the quick-release structure between the lens bracket and the mounting bracket, making it convenient for mobile phones to be used in combination with various optical elements (e.g., filters and lenses) for shooting.

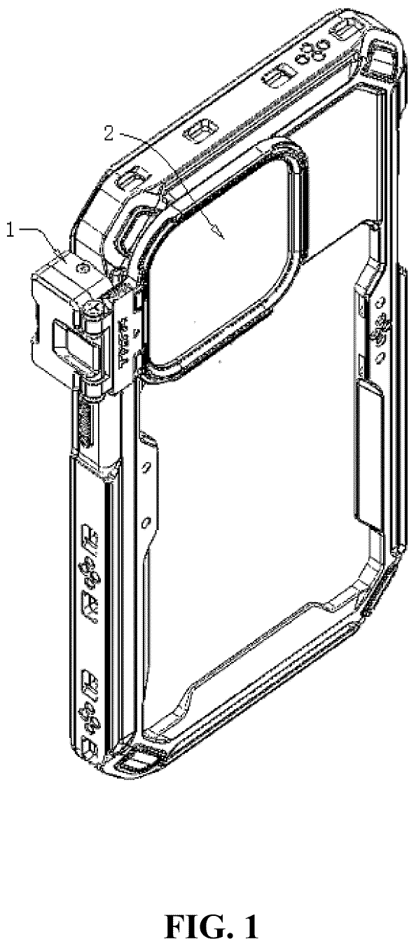

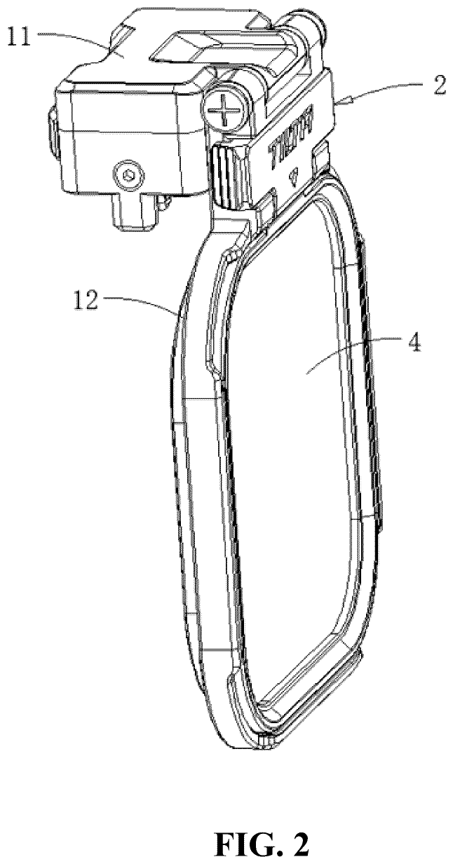

Referring to FIGS. 1 and 2. In some aspects, a lens adapter bracket is provided, which includes a mounting bracket 1 and a lens bracket 2. The mounting bracket 1 is detachably mounted on an electronic device kit and is configured to be positioned at the lens location of the electronic device. Openings 123 are provided on the mounting bracket 1 to expose the camera lens, flashlight, and recording hole of the electronic device. The lens bracket 2 is used to mount an optical element 4 (e.g., filter or lens) and is magnetically attracted to the mounting bracket 1. The optical element 4, mounted on the lens bracket 2, is fixed onto the mounting bracket 1 along with the lens bracket 2, thereby covering the electronic device's camera lens for shooting. Users can conveniently hold the electronic device to shoot using various attached optical elements 4. The detachable connection for removing lenses simplifies the lens replacement process and significantly reduces the steps involved in optical element 4 change and disassembly. In the embodiment of the present disclosure, the electronic device is a mobile phone, and it is understood that the optical element 4 can be a filter or lens.

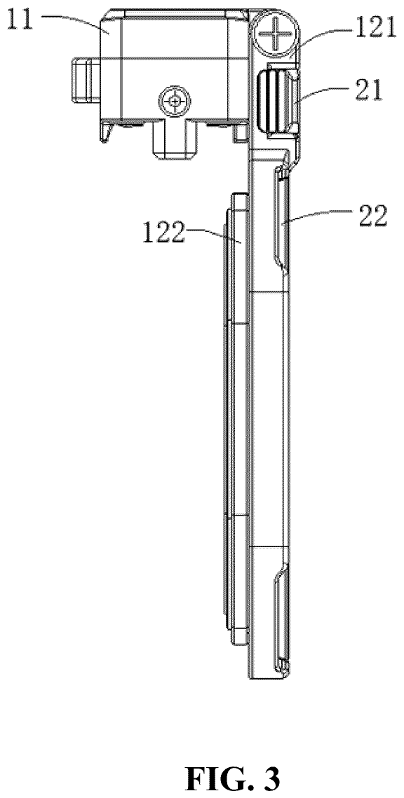

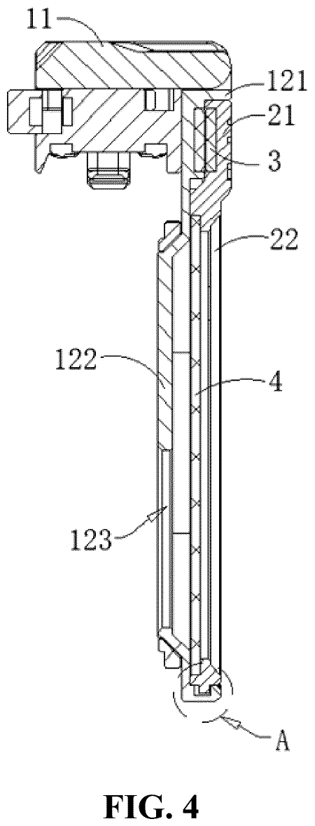

In the embodiment of the present disclosure, referring to FIGS. 3 and 4. Magnets 3 are provided on the mounting bracket 1 and the lens bracket 2 to magnetically connect the mounting bracket 1 and the lens bracket 2, enabling a detachable connection between the mounting bracket 1 and the lens bracket 2. This connection is cost-effective and simple to operate. In alternative embodiments, the magnets 3 can be configured as magnetic sheets or strips to suit different field conditions.

Referring to FIG. 2. The mounting bracket includes a quick-release part 11 and a rotating part 12. The quick-release part 11 is utilized for detachable connection with the electronic device, whereas the rotating part 12 is rotatably mounted onto the quick-release part 11. The rotating part 12 can be rotated to move away from or towards the camera lens of the electronic device, with the lens bracket 2 adsorbed onto the rotating part 12. In the embodiment disclosed herein, the rotating part 12 can be adjusted by rotating it along the rotational axis to move closer to or away from the camera lens of the electronic device, enabling the electronic device to switch to the original lens for shooting at any time without removing the optical element 4. This operation is straightforward and convenient.

Additionally, referring to FIG. 2. A damping element, which can be a damper, is provided at the rotational axis of the rotating part 12. This allows the rotating part 12 to hover at any position during rotation, preventing it from shaking with the movement of the electronic device. Consequently, this enhances the stability of both the rotating part 12 and the lens bracket 2.

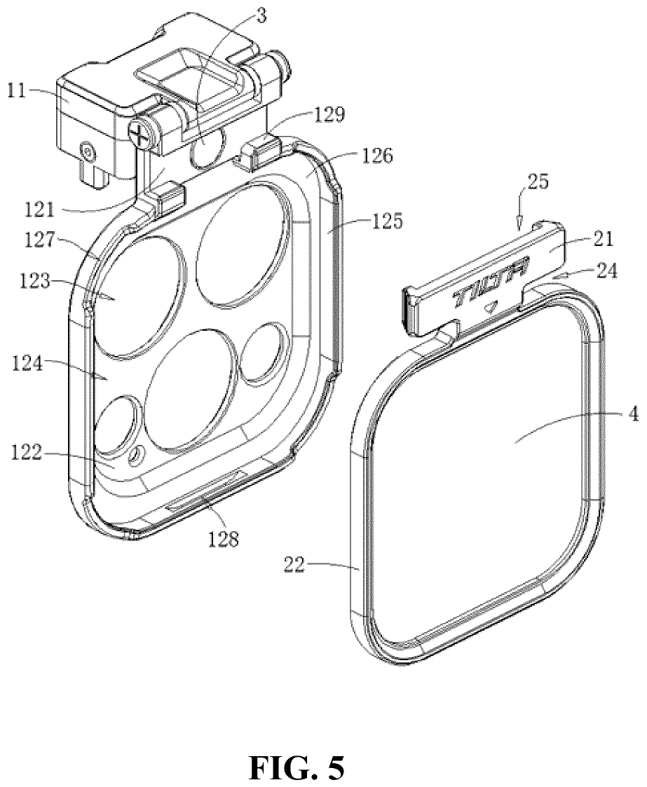

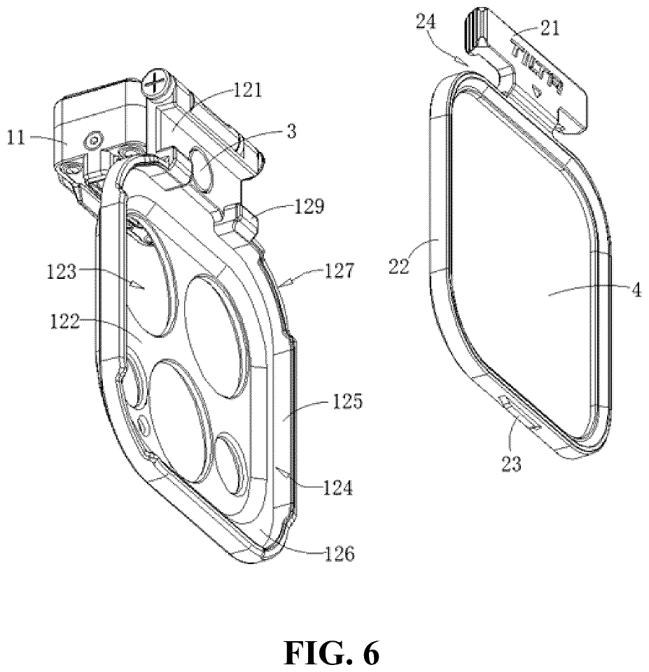

Referring to FIGS. 5 and 6, the rotating part 12 includes a mounting part 121 and a positioning part 122, wherein the mounting part 121 is rotatably connected to the quick-release part 11, and the positioning part 122 is configured to surround around the camera of the electronic device. The openings 123 are all formed within the positioning part 122, and their specific positions, quantities, and arrangements are determined according to the model of the electronic device. Since existing mobile phone lenses protrude relative to the phone body, the installation position of the mounting bracket can also be determined through the openings 123 and the lens. The positioning part 122 can rotate away from or towards the lens of the electronic device via the mounting part 121. The lens bracket 2 includes a connecting part 21 and a lens part 22. Magnets 3 are disposed on both the connecting part 21 and the mounting part 121, and the connecting part 21 cooperates with and is magnetically attracted to the mounting part 121. The lens part 22 is used to mount an optical element 4 and cooperates with the positioning part 122. Once the connecting part 21 and the mounting part 121 are magnetically fixed, the optical element 4 of the lens part 22 covers the positioning part 122, i.e., the lens of the electronic device.

Referring to FIGS. 5 and 6. A limiting part 125 is provided around the perimeter of the positioning part 122, and the limiting part 125 and the positioning part 122 form a limiting slot 124 for embedding the lens part 22. During use, the lens part 22 is enclosed within the limiting slot 124 formed by the limiting part 125 and the positioning part 122, providing support, limiting, and anti-deviation functions to the lens part 22, and enhancing the relative stability between the lens part 22 and the electronic device. The positioning part 122 is recessed and forms a step surface 126 with the limiting part 125. The lens part 22 fits against the step surface 126, which supports the lens part 22 and maintains a constant distance and parallelism between the optical element 4 and the lens of the electronic device, ensuring stability in photographic performance.

Furthermore, in the embodiment disclosed herein, referring to FIGS. 5 and 6. The limiting part 125 is configured as a structure surrounding the perimeter of the positioning part 122, and the limiting part 125 is provided with unloading slots 127. The limiting slot 124 is disposed at the corners of the positioning part 122. The unloading slots 127 are provided to expose the lens part 22, allowing the lens part 22 to be installed or removed at the positions of the two unloading slots 127, which facilitates changing lens/filters in a simple and convenient manner.

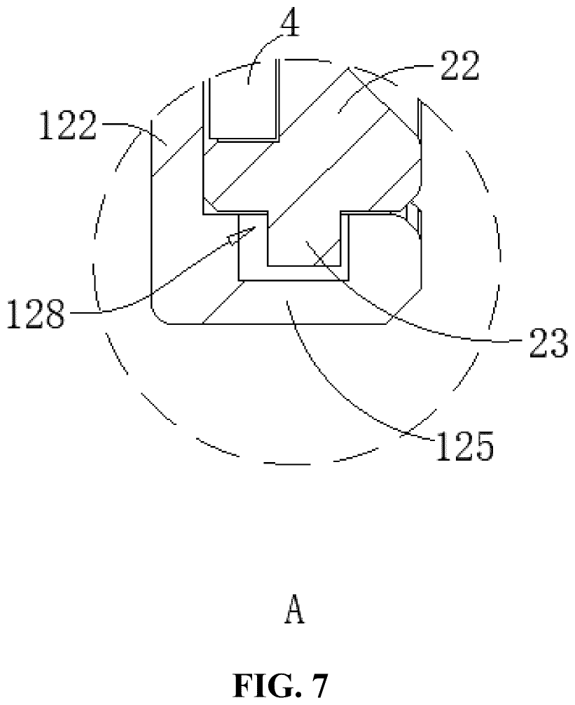

Referring to FIG. 7, to further ensure stability between the optical element 4 and the lens of the electronic device, a fixture block 23 is provided on the side of the lens part 22 facing away from the connecting part 21. The limiting part 125 is provided with a clamping slot 128 for inserting the fixture block 23. When the clamping slot 128 cooperates with the fixture block 23, i.e., when the fixture block 23 is inserted into the clamping slot 128, the magnet 3 on the connecting part 21 attracts the magnet 3 on the mounting part 121. By inserting the fixture block 23 into the clamping slot 128, one end of the lens bracket 2 and the mounting bracket 1 can be pre-positioned, and the other end of the lens bracket 2 and the mounting bracket can be fixed by the attraction of the two magnets 3, thereby ensuring stability between the lens bracket 2 and the mounting bracket 1 and improving stability between the optical element 4 and the lens of the electronic device.

Referring to FIGS. 5 and 6, the mounting part 121 includes at least two positioning blocks 129, and the connecting part 21 includes positioning notches 24 for accommodating the positioning blocks 129. In the embodiment disclosed herein, two positioning blocks 129 are disposed between the mounting part 121 and the positioning part 122 and are symmetrically arranged around the mounting part 121. A positioning notch 24 is positioned between the connecting part 21 and the lens part 22. The connecting part 21 is recessed to form a clamping slot 25 that can be fitted over the mounting part 121. In the installed state of the lens bracket 2, the clamping slot 25 of the connecting part 21 encloses the mounting part 121.

In the embodiment disclosed herein, the positioning blocks 129 can be configured in an “L” shape. When installing the lens bracket 2, as the positioning blocks 129 are engaged into the positioning notches 24, the “L”-shaped positioning blocks 129 provide space for the lens bracket 2 to “drop down”, allowing the fixture block 23 to be latched into the clamping slot 128 for positioning, while the entire lens part 22 is embedded within the limiting slot 124 for positioning. The clamping slot 25 encloses the mounting part 121, and the two sets of magnets 3 attract each other for fixation, thereby mounting the mounting bracket and the lens bracket. This enables quick installation and removal of the two components while ensuring stability in their connection.

The aforementioned illustration of particular instances is solely intended to facilitate comprehension of the present disclosure; it is not employed to restrict the scope of the present disclosure. For the technical professionals within the pertinent technical domain, in accordance with the conceptual framework of the present disclosure, a number of straightforward inferences, adaptations, or substitutions may also be formulated.

What is claimed is:

1. A lens adapter bracket, comprising:
a mounting bracket and a lens bracket;
the mounting bracket is configured to detachably mounted on an electronic device, and the mounting bracket is configured to be positioned at a lens location of the electronic device;
wherein an opening is provided on the mounting bracket to expose a lens of the electronic device; and
wherein the lens bracket is configured to mount an optical element, and the lens bracket is detachably connected to the mounting bracket.

2. The lens adapter bracket according to claim 1, wherein magnets for mutual attraction are disposed on the mounting bracket and the lens bracket to enable detachable connection between the lens bracket and the mounting bracket.

3. The lens adapter bracket according to claim 2, wherein the mounting bracket comprises a limiting slot, and a clamping slot is provided on a slot wall of the limiting slot; and
wherein an end of the lens bracket opposite a magnet comprises a fixture block capable of engaging with the clamping slot.

4. The lens adapter bracket according to claim 1, wherein the mounting bracket comprises a quick-release part and a rotating part;
wherein the quick-release part is configured for detachable connection with the electronic device;
wherein the rotating part is rotatably mounted on the quick-release part and is capable of rotating to move away from or toward a camera of the electronic device; and
wherein the lens bracket is detachably connected to the rotating part.

5. The lens adapter bracket according to claim 4, wherein the rotating part comprises a mounting part and a positioning part;
wherein the mounting part is rotatably connected to the quick-release part;
wherein the positioning part is configured to surround around the lens of the electronic device and comprises the opening;
wherein the positioning part is capable of rotating away from or toward the lens of the electronic device via the mounting part;
wherein the lens bracket comprises a connecting part and a lens part;
wherein the connecting part is detachably connected to the mounting part; and
wherein the lens part is configured for mounting the optical element and cooperates with the positioning part.

6. The lens adapter bracket according to claim 5, wherein a periphery of the positioning part is surrounded by a limiting part, forming a limiting slot with the positioning part for insertion and accommodation of the lens part.

7. The lens adapter bracket according to claim 6, wherein the positioning part is concave and forms a step surface with the limiting part; and
wherein the lens part is supported by the step surface.

8. The lens adapter bracket according to claim 6, wherein the limiting part comprises an unloading slot for exposing and detaching the lens part.

9. The lens adapter bracket according to claim 4, wherein a damping member is disposed at a rotating shaft of the rotating part, enabling the rotating part to remain at a plurality of positions.

10. The lens adapter bracket according to claim 5, wherein the mounting part comprises at least two positioning blocks, and the connecting part comprises positioning notches for accommodating the at least two positioning blocks.
